(19) United States
(12) Patent Application Publication
(10) Pub. No.: US 2014/0232119 A1
(43) Pub. Date: Aug. 21, 2014

(54) AUXILIARY SAFETY MODULE FOR DOORS FITTED WITH AN ANTI-PANIC OPENING DEVICE

(71) Applicant: SAVIO S.p.A., Chiusa San Michele (Torino) (IT)

(72) Inventor: Aimone BALBO DI VINADIO, Chiusa San Michele (Torino) (IT)

(73) Assignee: SAVIO S.p.A., Chiusa San Michele (Torino) (IT)

(21) Appl. No.: 14/182,191

(22) Filed: Feb. 17, 2014

(30) Foreign Application Priority Data
Feb. 21, 2013 (IT) TO2013A000142

(51) Int. Cl. E05C 1/08

(52) U.S. Cl. CPC E05C 1/08
USPC 292/163

(57) ABSTRACT

Auxiliary safety module for doors fitted with an anti-panic opening device, comprising: a stationary support having a base wall and two parallel side walls projecting from said base wall, a slider movable relative to the stationary support along a longitudinal direction (C) between a closed position and an open position, and elastically pushed towards the closed position, a spring latch movable relative to the stationary support between an extracted position and a retracted position, elastically pushed towards the extracted position and connected to the slider so that when the slider is in the closed position, the latch is elastically pushed towards the extracted position, and when the slider is in the open position, the latch is retained in the retracted position, a hook hinged to the stationary support about an axis perpendicular to said longitudinal direction.

### CROSS-REFERENCE TO RELATED APPLICATIONS

This application claims benefit of Italian patent application number TO2013A000142, filed Feb. 21, 2013, which is herein incorporated by reference.

### BACKGROUND OF THE INVENTION

1. Field of the Invention

The present invention relates in general to anti-panic opening devices for doors and regards an auxiliary safety module for doors fitted with an anti-panic opening device.

2. Description of Prior Art

A typical anti-panic opening device for doors comprises a horizontal bar that controls the opening of a main lock arranged at the control bar. To increase the safety of doors equipped with anti-panic opening devices, auxiliary safety modules are frequently used that are installed at the upper and lower sides of the door. The opening of the auxiliary safety modules is controlled by the main lock through transmission mechanisms.

The document EP-A-1887170 by the same applicant describes various solutions of auxiliary safety modules equipped with a spring latch and an oscillating hook. The auxiliary safety modules known from this document envisage a slider, movable between an open position and a closed position, which controls the opening of the hook and the oscillating latch. The oscillating latch is hinged about a transverse axis with respect to the direction of movement of the slider and is designed to engage a striker located on the upper or lower horizontal side of the frame. The auxiliary safety modules are also equipped with an oscillating probe that retains the slider in the open position.

A drawback of the known solutions from the document EP-A-1887170 is that the oscillating latch provides little protection against burglary attempts.

Another drawback of the known solutions is that the fixed strikers for the oscillating latch and for the hook are arranged on two mutually perpendicular sides of the frame, which complicates the installation and alignment of the door. A further drawback is that the oscillating arrangement of the probe complicates the structure of the auxiliary safety module.

### SUMMARY OF THE INVENTION

The present invention aims to provide an auxiliary safety module for doors fitted with an anti-panic opening device that has a simpler structure and which offers greater guarantees of security against burglary attempts.

According to the present invention, this object is achieved by an auxiliary safety module having the features forming the subject of claim 1.

The claims form an integral part of the technical disclosure provided in relation to the invention.

### BRIEF DESCRIPTION OF THE DRAWINGS

The present invention will now be described, purely by way of non-limiting example, with reference to the attached drawings, wherein:

FIG. 1 is a front view of a door fitted with an anti-panic opening device and with two auxiliary safety modules according to the present invention.

FIGS. 2 and 3 are views on an enlarged scale of the auxiliary safety module indicated by the arrow II in FIG. 1 in the closed position and the open position, respectively.

FIG. 4 is an exploded perspective view of certain components of the auxiliary safety module according to the invention.

FIG. 5 is a partially exploded perspective view of the auxiliary safety module according to the invention;

FIG. 6 is a partially sectioned front view of the auxiliary safety module, according to the invention, in the closed position; and

FIGS. 7 and 8 are partially sectioned plan views illustrating the part indicated by the arrow VII in FIG. 6.

### DETAILED DESCRIPTION

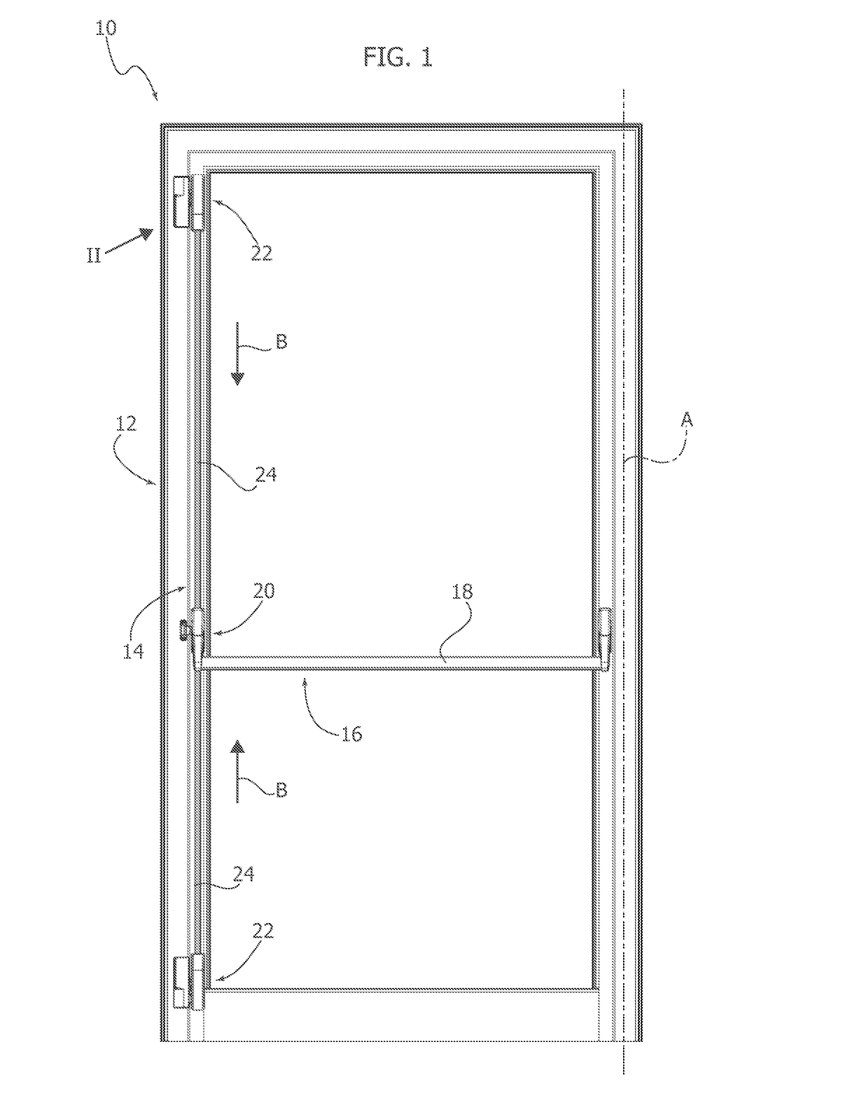

With reference to FIG. 1, numeral 10 indicates a door fitted with an anti-panic opening device. The door 10 comprises a fixed frame 12 and a wing 14 hinged to the fixed frame 12 about a vertical axis A. The wing 14 is fitted with an anti-panic opening device 16 including a horizontal bar 18 and a main lock 20. The anti-panic opening device 16 can for example be of the type described in European patent application no. 12171033.9 of the same applicant.

The wing 14 comprises two auxiliary safety modules 22 mounted at the upper end and the lower end of the wing 14. Each auxiliary safety module 22 is connected to the main lock 20 by means of a respective rod 24. The main lock 20 is configured to control the movement of the rods 24 in the direction indicated by the arrows B when the bar 18 is pressed towards the door.

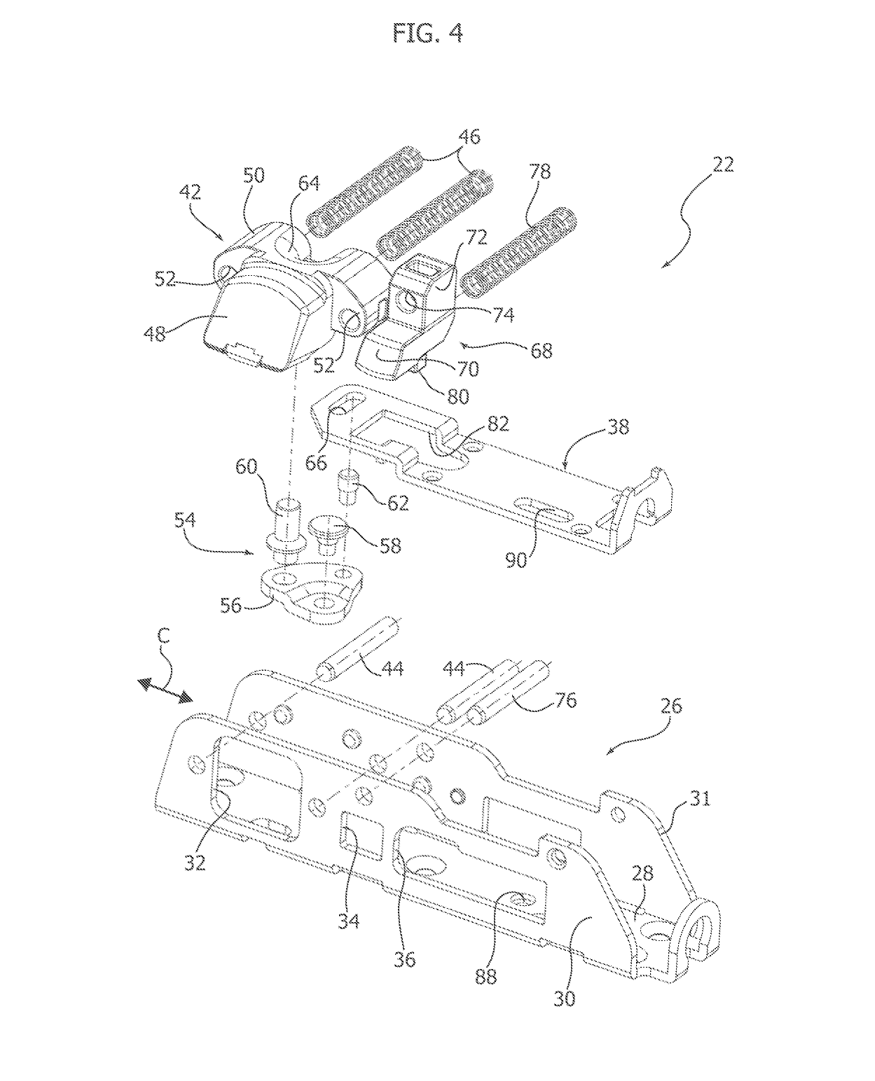

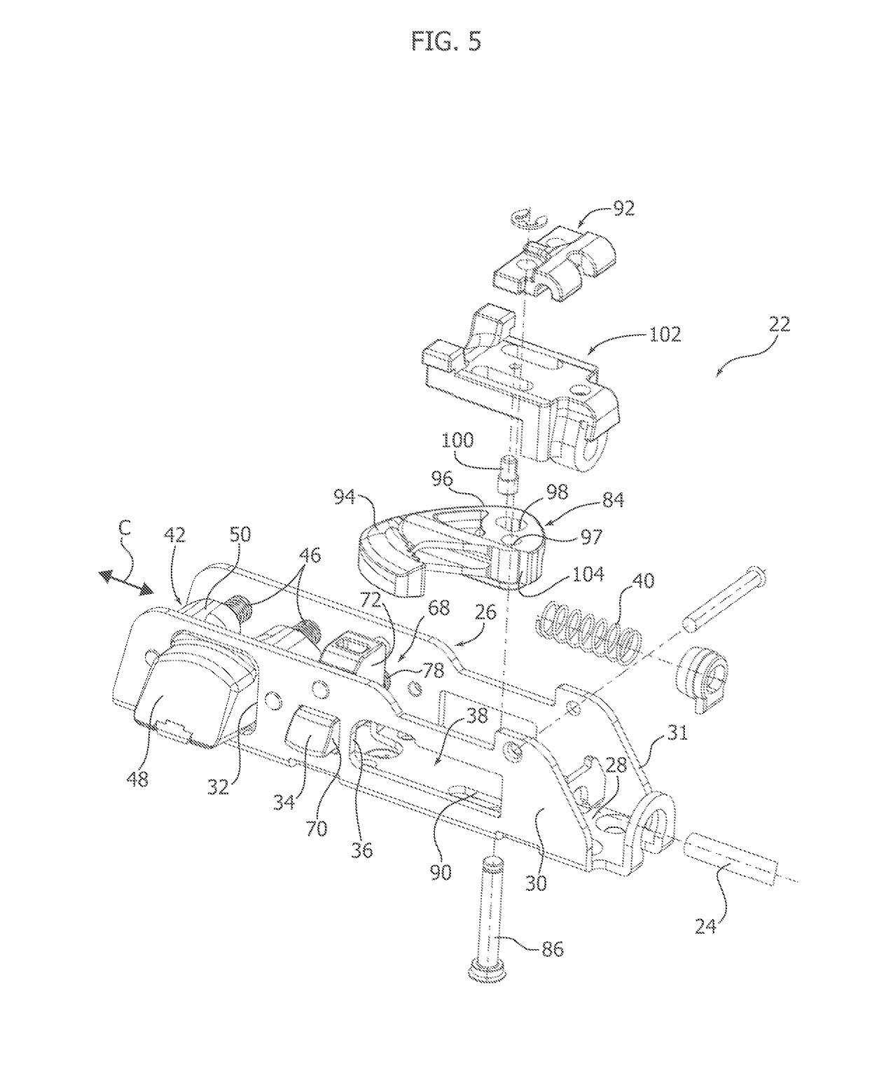

With reference to FIG. 4, the auxiliary safety module 22 comprises a stationary support 26, which is designed to be fixed to the wing 14 in the immediate vicinity of the vertical edge of the wing 14 opposite to the pivot axis A. The stationary support 26 has a base wall 28 and two side walls 30, 31 parallel to each other and which protrude from the base wall 28. In cross section, the stationary support 26 is essentially U-shaped and is preferably formed of bent sheet metal. The side wall 30 of the stationary support 26 is equipped with three openings 32, 34, 36. The auxiliary safety module 22 comprises a slider 38, preferably made of stamped sheet metal, mounted adjacent to the base wall 28 between the two side walls 30, 31 of the stationary support 26. The slider 38 is movable relative to the stationary support 26 in a longitudinal direction C between a closed position and an open position. The slider 38 is connected to one end of a respective rod 24. As is visible in FIG. 5, an elastic element in compression 40 is arranged between the slider 38 and the stationary support 26, and tends to push the slider 38 towards the closed position.

With reference to FIG. 4, the auxiliary safety module 22 comprises a spring latch 42 movable relative to the stationary support 26 along a direction perpendicular to the longitudinal direction C between an extracted position and a retracted position. The spring latch 42 is guided by a pair of pins 44 fixed between the side walls 30, 31 of the stationary support 26. Two compression coil springs 46 are arranged coaxially to respective pins 44 and push the latch 42 toward the extracted position. The latch 42 has a head 48 that protrudes outwards from the stationary support 26 through the opening 32. The latch 42 has a body 50 provided with holes 52 through which respective pins 44 extend. The coil springs 46 are arranged in compression between the body 50 of the latch 42 and the wall 31 of the stationary support 26.

The spring latch 42 is connected to the slider 38 by means of a transmission mechanism 54. The transmission mechanism 54 comprises a plate 56 hinged to the base wall 28 of the stationary support 26 by a pin 58. The plate 56 has two projecting pins 60, 62. The pin 60 engages an opening 64 formed in the body 50 of the latch 42. The pin 62 engages a slit 66 of the slider 38 elongated along a transverse direction with respect to the longitudinal direction C. The transmission mechanism 54 moves the spring latch 42 from the extracted position towards the retracted position against the action of the springs 46 following the movement of the slider 38 from the closed position to the open position.

The auxiliary safety module 22 comprises a probe 68 movable relative to the stationary support 26 along a transverse direction with respect to the longitudinal direction C between an extracted position and a retracted position. The probe 68 has a head 70 that protrudes outwards from the stationary support 26 through the opening 34, and a body 72 having a hole 74 through which a pin 76 extends, fixed between the two side walls 30, 31 of the stationary support 26. A compression coil spring 78 is arranged coaxially to the pin 76 between the body 72 and the side wall 31 and pushes elastically the probe 68 towards the extracted position.

The probe 68 has a stop pin 80, which is arranged within an opening 82 of the slider 38. The opening 82 is essentially L-shaped with a first branch parallel to the longitudinal direction C and a second branch perpendicular to the transverse direction C.

With reference to FIG. 5, the auxiliary safety module 22 comprises a hook 84 hinged to the stationary support 26 about an axis perpendicular to the longitudinal direction C by means of a pin 86. The pin 86 extends through a hole 88 in the base wall 28 (FIG. 4) and through a slot 90 elongated in the longitudinal direction C of the slider 38. The end of the pin 86 opposite to the base wall 28 engages a bracket 92 fixed between the side walls 30, 31 of the stationary support 26.

The hook 84 has a locking portion 94 that protrudes outwards from the stationary support 26 through the opening 36 of the side wall 30, and a base 96 having a hole 97 through which the pin 86 extends. The hook 84 is free to rotate about the pin 86. The base 96 of the hook 84 has a cam opening 98 in which a pin 100 is engaged, fixed to an anchor 102 attached to the slider 38. The cam opening 98 of the hook 84 is shaped in such a way that when the slider 38 is in the closed position, the hook 84 is in a locked position and when the slider 38 is in the open position, the hook 84 is rotated into an unlocked position.

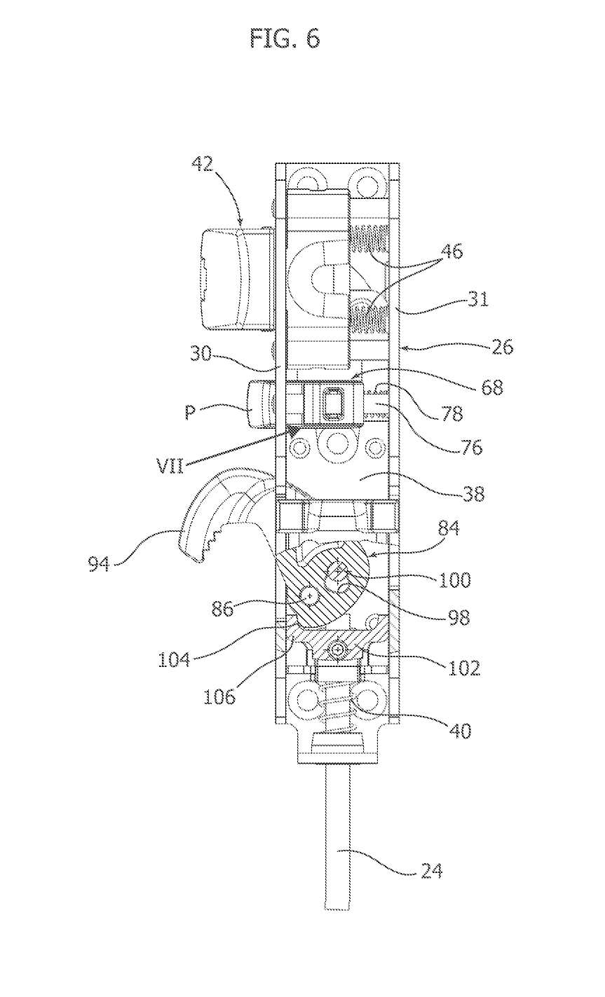

With reference to FIG. 6, the base 96 of the hook 84 has a stop surface 104 located on the opposite side of the pin 86 with respect to the locking portion 94. In the closed position of the slider 38 an appendix 106 of the anchor 102 comes into abutment with the stop surface 104 preventing a rotation of the hook 84 towards the unlocked position. In this way, this prevents burglary attempts that are carried out by attempting to rotate the hook 84 towards the unlocked position by acting from the external side of the door by means of thin objects inserted into the gap between the facing sides of the wing and the frame.

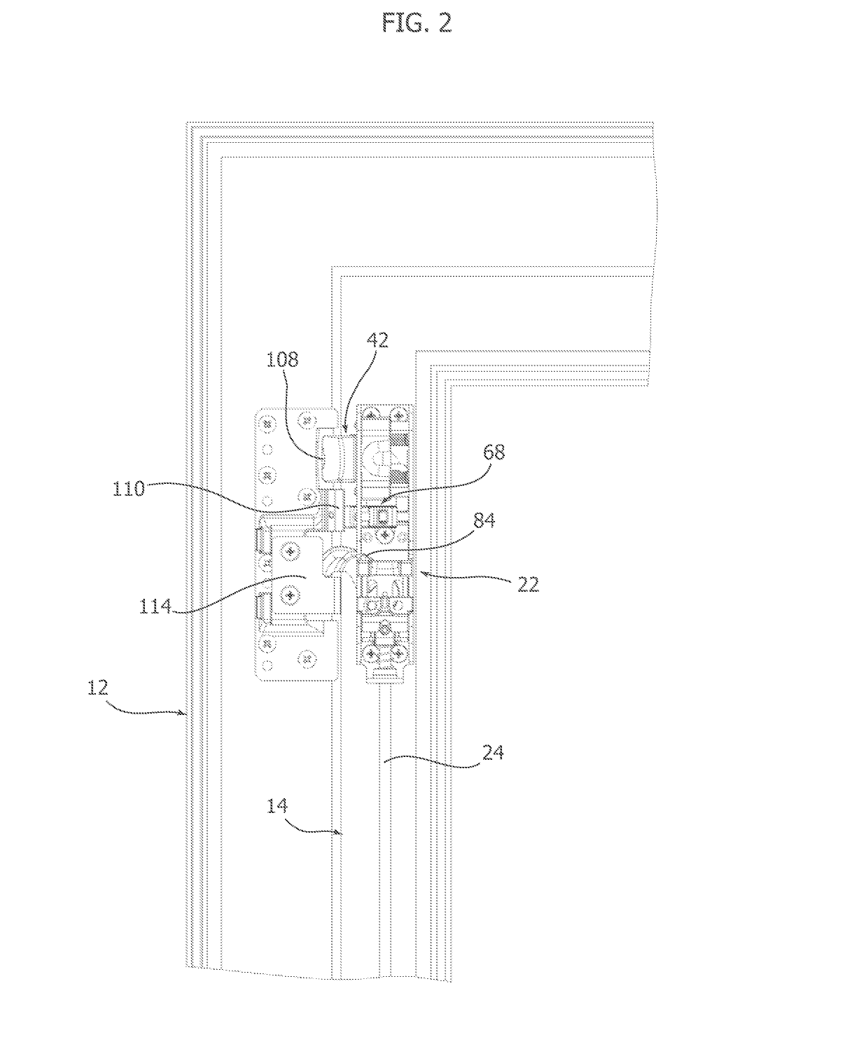

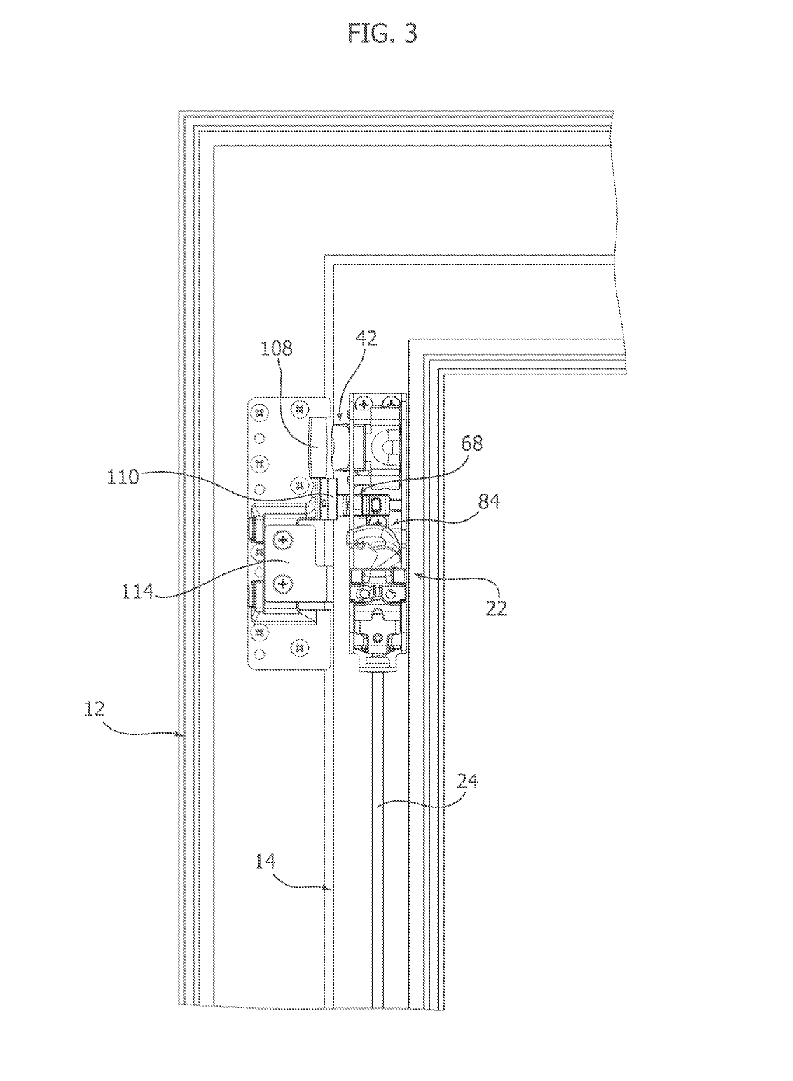

FIGS. 2 and 3 illustrate the auxiliary safety module 22 mounted on the wing 14, in the locked and unlocked conditions of the wing, respectively. The auxiliary safety module 22 faces three strikers 108, 110, 114 fixed to the frame 12. The first striker 108 cooperates with the spring latch 42, the second striker 110 cooperates with the probe 68 and the third striker 114 has a seat into which the blocking portion 94 of the hook 84 is inserted in the locked position.

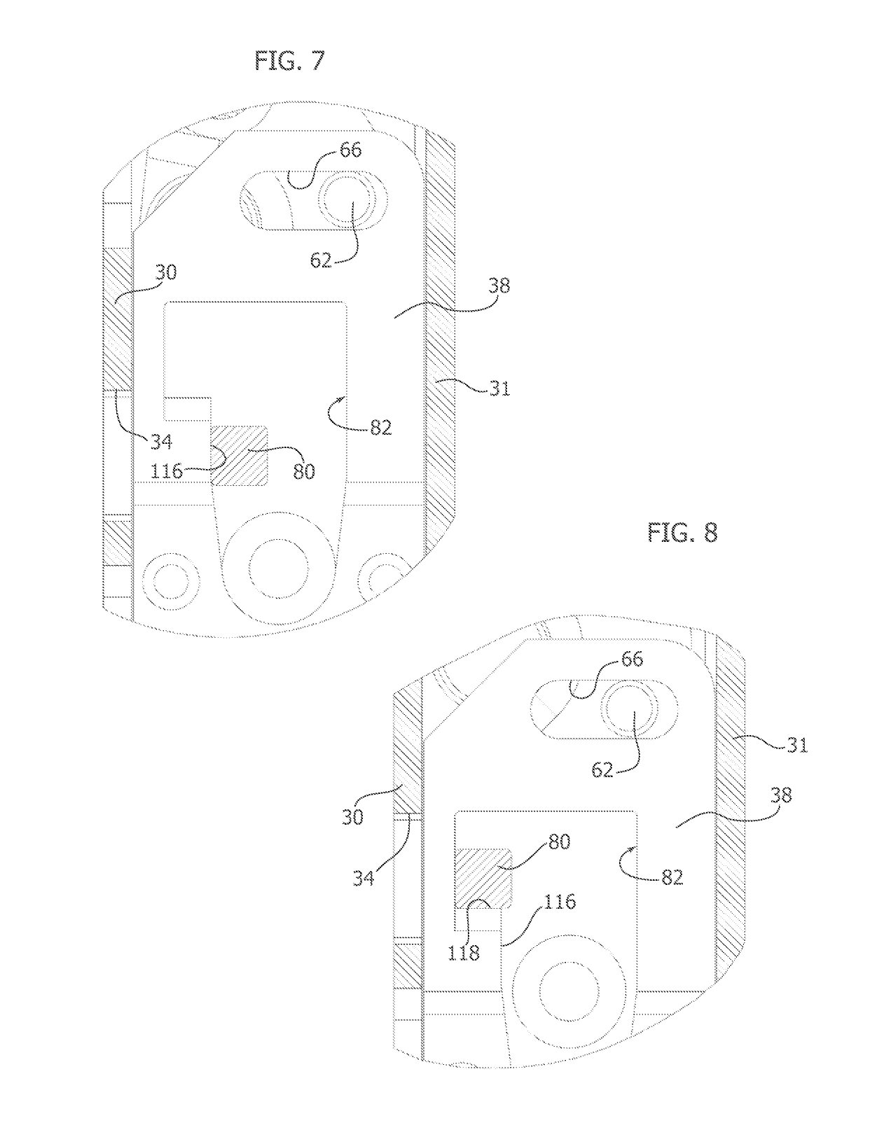

When the slider 38 is in the closed position, the spring latch 42 is pushed by the springs 46 towards its extracted position and the hook 84 is rotated towards the locked position. In this condition, the head 48 of the spring latch 42 interferes with the striker 108, and the locking portion 94 of the hook 84 is inserted into the seat of the striker 114. With reference to FIG. 7, when the slider 38 is in the closed position, the stop pin 80 of the probe 68 is located alongside the branch of the opening 82 parallel to the longitudinal direction C. The stop pin 80 rests against a surface 116 of the opening 82 and the probe 68 is held in the retracted position.

When the slider 38 is pulled from the rod 24 towards the open position the spring latch 42 is moved from the transmission mechanism 54 towards the retracted position against the action of the springs 46, and the hook 84 is rotated into its unlocked position by cooperation of the pin 100 with the cam 98. With reference to FIG. 3, in this condition the hook 84 is rotated within the stationary support 26 and is disengaged from the striker 114. The head 48 of the spring latch 42 is disengaged from the striker 108, and the wing 14 is then unlocked.

With reference to FIG. 8, when the slider 38 is in the open position, the stop pin 80 of the probe 68 is located alongside the transverse branch of the opening 82. The stop pin 80 forms an abutment against which a surface 118 of the slider 38 rests transverse with respect to the longitudinal direction C. In this condition the slider 38 cannot return to the closed position. Therefore, when the wing 14 is open, the hook 84 is retained in the unlocked position and the spring latch 42 is retained in the retracted position. In the open position of the slider 38, the probe 68 is in the extracted position illustrated in FIG. 3.

When the wing 14 is placed alongside the frame 12, the head 70 of the probe 68 interferes with the counterpart 110. The probe 68 is pushed toward its retracted position. The stop pin 80 disengages the stop surface 118 and the slider 38 is free to return towards the closed position under the thrust of the elastic element 40. The return of the slider 38 into the closed position returns the hook 84 to the locked position and the spring latch 42 into the extracted position.

Of course, without prejudice to the principle of the invention, the details of construction and the embodiments may vary widely with respect to those described and illustrated without departing from the scope of the invention as defined by the claims that follow.

1. Auxiliary safety module for doors fitted with an anti-panic opening device, comprising:
a stationary support having a base wall and two parallel side walls projecting from said base wall;
a slider movable relative to the stationary support along a longitudinal direction between a closed position and an open position and elastically pushed towards the closed position;
a spring latch movable relative to the stationary support between an extracted position and a retracted position, elastically pushed towards the extracted position and connected to the slider so that when the slider is in the closed position, the latch is elastically pushed towards the extracted position, and when the slider is in the open position, the latch is retained in the retracted position;
a hook hinged to the stationary support about an axis perpendicular to said longitudinal direction and movable between a locking position and an unlocking position, the hook being connected to the slider so that when the slider is in the closed position, the hook is in the locked position, and when the slider is in the open position the hook is in the unlocked position; and
a probe movable between an extracted position and a retracted position, elastically pushed towards the extracted position and cooperating with the slider to retain the slider in the open position when the probe is in the extracted position, wherein:
the spring latch is movable between said extracted position and said retracted position along a straight direction, perpendicular to said longitudinal direction;
the probe is movable between said extracted position and said retracted position along a straight direction parallel to the direction of movement of the latch; and
the latch, the probe and the hook project outwards from said stationary support through the same side wall.

2. A module according to claim 1, wherein the probe has a stop pin that engages an opening of the slider having a first branch parallel to said longitudinal direction and a second branch perpendicular to said longitudinal direction.

3. A module according to claim 1, wherein said spring latch and said probe are movable along respective pins fixed between said side walls.

4. A module according to claim 1, wherein said hook has a cam opening engaged by a pin fixed with respect to said slider, the cam opening being shaped so as to control the movement of said hook from the locked position to the unlocked position following the movement of the slider from the open position to the closed position, and vice versa.

5. A module according to claim 1, wherein said spring latch is connected to the slider through a transmission mechanism including a plate hinged to the base wall of the stationary support and having two protruding pins, the first of which engages an opening of the latch and the second of which engages a slit of the slider which extends transversely with respect to said longitudinal direction.
